(19) United States
(12) Patent Application Publication
(10) Pub. No.: US 2025/0023432 A1
(43) Pub. Date: Jan. 16, 2025

(54) SENSOR ARRANGEMENT AND ELECTRIC MACHINE

(71) Applicant: Schaeffler Technologies AG & Co. KG, Herzogenaurach (DE)

(72) Inventor: Thilo Winterling, Herzogenaurach (DE)

(21) Appl. No.: 18/713,832

(22) PCT Filed: Oct. 12, 2022
(86) PCT No.: PCT/DE2022/100756

§ 371 Date: May 28, 2024

(30) Foreign Application Priority Data
Nov. 26, 2021 (DE) 102021131033.4

(51) Int. Cl. H02K 11/225

(52) U.S. Cl. CPC H02K 11/225

(57) ABSTRACT

The invention relates to a sensor arrangement (1) for determining an angular position of a rotatable component, such as in particular a shaft (2), comprising a first annular sensor target (3) with a plurality of teeth (4) and grooves (5) distributed over the circumference and arranged alternately over the circumference, and also comprising a first inductive sensor (6), which is arranged at a distance axially from the first sensor target (3), and the sensor target (3) and the first inductive sensor (6) are rotatable in relation to one another about a common axis of rotation (7), wherein the first inductive sensor (6) has a first coil (8) and a second coil (9), which respectively extend in a radial plane (10) in relation to the axis of rotation (7), wherein the first coil (8) follows a sinusoidal path along a circular circumference (11) and the second coil (9) follows a path that is phase-offset thereto, in particular a cosinusoidal path, along the circular circumference (11), wherein the first inductive sensor (6) comprises an energizable third coil (12), wherein the energizable third coil (12) is arranged radially offset inside the first coil (8) and the second coil (9), and the grooves (5) are open radially inwards.

### CROSS-REFERENCE TO RELATED APPLICATION

The present application is the U.S. National Phase of PCT Patent Application Number PCT/DE2022/100756, filed on Oct. 12, 2022, which claims priority to German Patent Application Serial Number 10 2021 131 033.4, filed on Nov. 26, 2021, the entire disclosures of which are incorporated by reference herein.

### TECHNICAL FIELD

The present disclosure relates to a sensor arrangement for determining an angular position of a rotatable component, such as in particular a shaft, comprising a first annular sensor target with a plurality of teeth and grooves distributed equidistantly over the circumference and arranged in an alternating manner over the circumference, and also comprising a first inductive sensor, which is arranged at a distance axially from the first sensor target, and the sensor target and the first inductive sensor are rotatable in relation to one another about a common axis of rotation, wherein the first inductive sensor has a first coil and a second coil, which respectively extend in a radial plane in relation to the axis of rotation, wherein the first coil follows a sinusoidal path along a circular circumference and the second coil follows a path that is phase-offset thereto, in particular a cosinusoidal path, along the circular circumference, wherein the first inductive sensor comprises an energizable third coil.

### BACKGROUND

Electric motors are increasingly being used to drive motor vehicles in order to create alternatives to internal combustion engines that require fossil fuels. Significant efforts have already been made to improve the suitability of electric drives for everyday use and also to be able to offer users the driving comfort they are accustomed to.

A detailed description of an electric drive can be found in an article in the German automotive magazine ATZ, volume 113, 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor that is arranged so as to be concentric and coaxial with a bevel gear differential, wherein a shiftable 2-speed planetary gear set is arranged in the drive train between the electric motor and the bevel gear differential, which is likewise positioned to be coaxial with the electric motor and the bevel gear differential or spur gear differential. The drive unit is very compact and allows for a good compromise between climbing ability, acceleration and energy consumption due to the shiftable 2-speed planetary gear set. Such drive units are also referred to as e-axles or electrically operable drive trains.

In addition to purely electrically operated drive trains, hybrid drive trains are also known. Such drive trains of a hybrid vehicle usually comprise a combination of an internal combustion engine and an electric motor, and enable, for example in urban areas, a purely electric mode of operation while at the same time permitting both sufficient range and availability, in particular when driving cross-country. In addition, it is also possible to drive the internal combustion engine and the electric motor at the same time in certain operating situations.

Sensors are used in many of these drive trains to acquire the angle and rotation information of an electric machine, for example. In a simplified principle, these sensors consist of a sensor rotor and a sensor stator. The sensor itself is usually connected in a fixed manner to the housing of the electric machine. The sensor rotor is usually a rotationally symmetrical component that rotates with the rotor of the electric machine.

Permanently excited synchronous machines are used in many of the electromobility applications mentioned at the outset. Such a permanently excited synchronous machine comprises a stator to be energized and a permanently excited rotor. The rotor usually comprises a shaft, balancing plates, laminated rotor cores, and magnets. The magnets are generally fixed in the laminated rotor cores.

To control such electronically commutated electric machines, electrical control variables are applied to the stator windings of the machine depending on the angular position of the rotor in order to drive it. The rotor position is usually acquired using a rotor position sensor and supplied to a control unit in order to generate the control signals required for commutation of the electric machine. Rotor position sensors provide either an analog electrical variable dependent on the position of the rotor, e.g., a voltage, signal pulses or a digitized indication of the absolute rotor position. Such rotor position sensors are generally known from the prior art, in which a signal transmitter (magnetic target) mounted in a non-rotatable manner on the rotor is read out by means of a magnetic field sensor mounted in a non-rotatable manner on the stator.

For example, DE 10 2009 001 353 A1 discloses an electric machine comprising a rotor with a rotor hub, a stator arranged in a stator housing, a cover which is attached to the stator housing and extends up to the inside diameter of the rotor hub and via which the rotor is mounted by means of a rotor bearing. The electric machine has a rotor position sensor for acquiring the rotational position of the rotor in relation to the magnetic field of the stator. The rotor position sensor is arranged on the cover in the vicinity of the rotor bearing in such a way that the rotor hub or a component connected to the rotor hub in a non-rotatable manner serves as the encoder track of the rotor position sensor.

In addition to rotor position sensors that work with a magnetic target, inductive rotor position sensors are also known, which offer the advantage that a permanent magnet can be dispensed with. This advantage is countered by the challenge of being able to generate sufficiently accurate sensor signals using an inductive sensor arrangement.

### SUMMARY

The object of the disclosure is therefore to provide a sensor arrangement for determining an angular position of a rotatable component, which can be designed to be particularly compact axially and which can provide a sufficiently good signal quality and accuracy of the angular position determination.

This object is achieved by a sensor arrangement for determining an angular position of a rotatable component, such as in particular a shaft, comprising a first annular sensor target with a plurality of teeth and grooves distributed equidistantly over the circumference and arranged in an alternating manner over the circumference, and also comprising a first inductive sensor, which is arranged at a distance axially from the first sensor target, and the sensor target and the first inductive sensor are rotatable in relation to one another about a common axis of rotation, wherein the first inductive sensor has a first coil and a second coil, which respectively extend in a radial plane in relation to the axis of rotation, wherein the first coil follows a sinusoidal path along a circular circumference and the second coil follows a path that is phase-offset thereto, in particular a cosinusoidal path, along the circular circumference, wherein the first inductive sensor comprises an energizable third coil, wherein the energizable third coil is arranged radially offset in the manner of a circular ring inside the first coil and the second coil, and the grooves are open radially inwards.

This has the advantage that the target of the sensor arrangement can be particularly well embedded in a structure of the rotatable component without affecting the measuring accuracy or measuring sensitivity of the sensor arrangement. This also allows for a particularly compact design of the sensor arrangement.

In principle, it is possible that the sensor arrangement is configured to determine either a relative or an absolute angular position.

According to an advantageous embodiment of the disclosure, the sensor target can have a basic shape in the manner of a circular ring. According to a further preferred further development of the disclosure, the rotatable component can rest at least in sections, preferably entirely, against the radially outer lateral surface of the sensor target, whereby the sensor arrangement can be designed to be particularly compact axially, since the sensor target can be inserted or integrated axially into the rotatable component.

Furthermore, according to a likewise advantageous embodiment of the disclosure, the rotatable component can be a hollow shaft with an inner lateral surface against which the radially outer lateral surface of the sensor target rests, whereby a particularly good non-rotatable connection can be formed between the sensor target and the hollow shaft.

According to a further particularly preferred embodiment of the disclosure, the sensor target can be fixed axially and in a non-rotatable manner in the hollow shaft by means of an interference fit, which is particularly favorable in terms of production engineering. In principle, it would also be conceivable for the sensor target to be inserted into the hollow shaft by means of a spline.

Furthermore, the disclosure can also be further developed in that the sensor arrangement has a control unit which is connected to the third coil for energizing and to the first coil and the third coil for evaluating signals. This allows the sensor arrangement to be designed, in particular, as a self-contained module, which is favorable in terms of assembly.

A control unit has, in particular, a wired or wireless signal input for receiving, in particular, electrical signals, such as sensor signals, for example. Furthermore, a control unit likewise preferably has a wired or wireless signal output for the transmission of, in particular, electrical signals, for example to electrical actuators or electrical consumers of the motor vehicle.

Open-loop control operations and/or closed-loop control operations can be carried out within the control unit. It is very particularly preferable that the control unit comprises hardware that is designed to run software. The control unit preferably comprises at least one electronic processor for executing program sequences defined in software.

The control unit can also have one or more electronic memories in which the data contained in the signals transmitted to the control unit can be stored and read out again. Furthermore, the control unit can have one or more electronic memories in which data can be stored in a modifiable and/or non-modifiable manner.

A control unit can comprise a plurality of control devices which are arranged in particular spatially separate from one another. Control devices are also referred to as electronic control units (ECU) or electronic control modules (ECM) and preferably have electronic microcontrollers for carrying out computing operations for processing data, particularly preferably using software. The control devices can preferably be interconnected with one another such that wired and/or wireless data exchange between control devices is made possible. In particular, it is also possible to interconnect the control devices with one another via bus systems, such as a CAN bus or LIN bus, for example.

In a likewise preferred embodiment of the disclosure, the control unit can be arranged in a region which lies radially inside the third coils, which also contributes to a very compact design of the sensor arrangement.

It can also be advantageous to further develop the disclosure in such a way that the first coil, the second coil and the third coil are formed on a common circuit board. In particular, the coils and the circuit board can be designed as a PCB (printed circuit board), which is advantageous in terms of production engineering on the one hand and favors a compact design of the sensor on the other.

According to a further preferred embodiment of the subject matter of the disclosure, the control unit can be arranged on the circuit board. In particular, it may be preferred that the circuit board is designed as a PCB and that at least parts of the control unit are printed on the circuit board.

The object of the disclosure is further achieved by an electric machine, in particular for a hybrid or fully electrically operable drive train of a motor vehicle, comprising a stator and a rotor rotatable relative to the stator, wherein the electric machine has a sensor arrangement according to any one of the preceding claims, by means of which the angular position of the rotor is determined.

Particularly preferably, the angular position is provided by the sensor arrangement as a measurement signal and used for commutation of the electric machine.

Electric machines are used to convert electrical energy into mechanical energy and/or vice versa, and generally comprise a stationary part referred to as a stator or stationary armature, and a part referred to as a rotor or moving armature and arranged movably relative to the stationary part. In the case of electric machines designed as rotary machines, a distinction is drawn in particular between radial flux machines and axial flux machines. A radial flux machine is characterized in that the magnetic field lines extend in the radial direction in the air gap formed between rotor and stator, while in the case of an axial flux machine the magnetic field lines extend in the axial direction in the air gap formed between rotor and stator.

The rotor can comprise a rotor shaft and one or more rotor bodies arranged on the rotor shaft in a non-rotatable manner. The rotor shaft can be hollow, which on the one hand results in weight savings and on the other hand allows the supply of lubricant or coolant to the rotor body. Furthermore, a rotor shaft designed as a hollow shaft can particularly preferably accommodate at least parts of the sensor arrangement.

The rotor of the electric machine can have a rotor body. A rotor body for the purposes of the disclosure is understood to mean the rotor without a rotor shaft. The rotor body is therefore composed in particular of the laminated rotor core and the magnetic elements introduced into the pockets of the laminated rotor core or fixed circumferentially to the laminated rotor core and any axial cover parts present for closing the pockets.

In particular, the sensor arrangement is connected to a control device of the electric machine. In this context, a control device is understood to mean a control unit for controlling the electric machine for the purpose of operating it. The control unit can particularly preferably comprise a power electronics module for energizing the stator or rotor. A power electronics module is preferably a combination of different components that provide open- or closed-loop control of a current to the electric machine, preferably including the peripheral components required for this purpose, such as cooling elements or power supply units. In particular, the power electronics module contains one or more power electronics components that are configured to provide open- or closed-loop control of a current. These are particularly preferably one or more power switches, such as power transistors. The power electronics unit particularly preferably has more than two, particularly preferably three, phases or current paths which are separate from one another and each have at least one separate power electronics component. The power electronics unit is preferably designed to provide open- or closed-loop control of a power per phase with a peak power, preferably continuous power, of at least 10 W, preferably at least 100 W, particularly preferably at least 1000 W.

A control device of the electric machine is used for the, in particular electronic, open- or closed-loop control of one or more technical systems of the motor vehicle. In particular, a control device can be provided for the open- or closed-loop control of an electric machine.

The disclosure is explained in more detail below with reference to drawings without limiting the general concept of the disclosure.

### BRIEF DESCRIPTION OF THE DRAWINGS

In the drawings:

FIG. 1 shows a detailed view of a sensor arrangement in a cross-sectional representation,

FIG. 2 shows a cross-sectional view of a sensor target arranged in a hollow shaft,

FIG. 3 shows a cross-sectional view of an inductive sensor,

FIG. 4 shows a cross-sectional view of a sensor target with an inductive sensor arranged in a hollow shaft,

FIG. 5 shows an axial sectional view of a sensor arrangement,

FIG. 6 shows an electric machine with a sensor arrangement in a schematic block diagram,

FIG. 7 shows a motor vehicle with an electric machine in a schematic block diagram.

### DETAILED DESCRIPTION

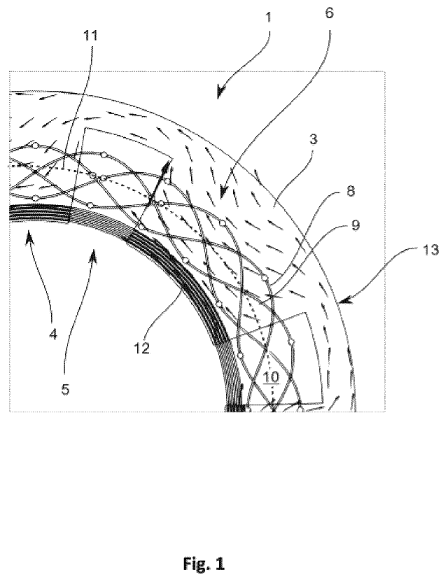

FIG. 1 shows a sensor arrangement 1 for determining an angular position of a shaft 2, comprising a first annular sensor target 3 with a plurality of teeth 4 and grooves 5 distributed equidistantly over the circumference and arranged in an alternating manner over the circumference. The sensor target 3 is formed from an electrically conductive material, in particular metal.

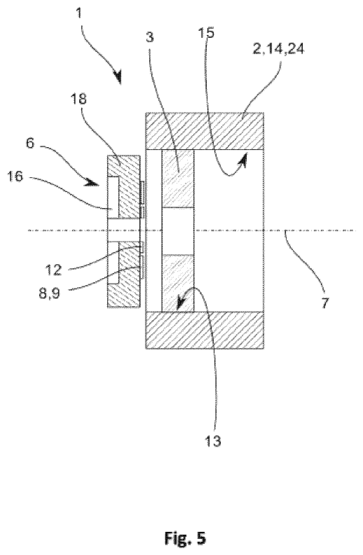

Furthermore, the sensor arrangement 1 has a first inductive sensor 6, which is arranged at a distance axially from the first sensor target 3, which is also clearly shown in FIG. 5. The sensor target 3 and the first inductive sensor 6 are rotatable in relation to one another about a common axis of rotation 7.

The first inductive sensor 6 has a first coil 8 and a second coil 9, which respectively extend in a radial plane 10 in relation to the axis of rotation 7.

The first coil 8 follows a sinusoidal path along a circular circumference 11 and the second coil 9 follows a cosinusoidal path phase-offset thereto along the circular circumference 11.

The first inductive sensor 6 further has an energizable third coil 12, wherein the energizable third coil 12 is arranged radially offset in the manner of a circular ring inside the first coil 8 and the second coil 9, which can be easily recognized from FIG. 1. The grooves 5 of the sensor target 3 are open radially inwards.

In FIG. 1, the direction of current flow through the sensor target 3 is indicated by arrows. This shows how the eddy currents in the sensor target 3, which are driven by the energizable transmitter coil 12 via induction, assume corresponding paths, symbolized by the current flow arrows. For this purpose, the sensor target 3 is designed such that the individual teeth 4 are electrically connected on the outer diameter via an annular conductor.

The energizable transmitter coil 12 is a circular coil and emits an alternating electromagnetic field after high-frequency energization—for example via a resonant circuit—but usually via a commercial IC arranged in the control unit 16. This field induces a voltage in the two receiver coils (first coil 8, second coil 9), wherein the local coupling is manipulated by the target shape of the sensor target 3. Due to the special shape of the first coil 8 and the second coil 9, an angular position can be determined after demodulation of the carrier signal via a trigonometric calculation pertaining to the two receiver coils (first coil 8, second coil 9).

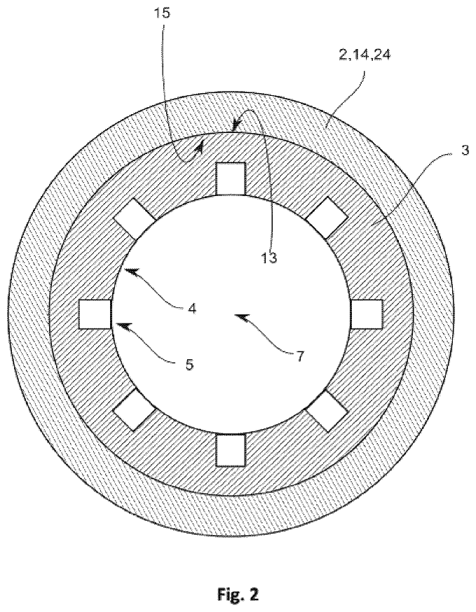

FIG. 2 shows the exposed sensor target 3, which rests against the rotatable component designed as a hollow shaft 13. More precisely, the hollow shaft 14 rests with an inner lateral surface 15 against the radially outer lateral surface 13 of the sensor target 3. For this purpose, the sensor target 3 was fixed axially and in a non-rotatable manner in the hollow shaft 14 by means of an interference fit.

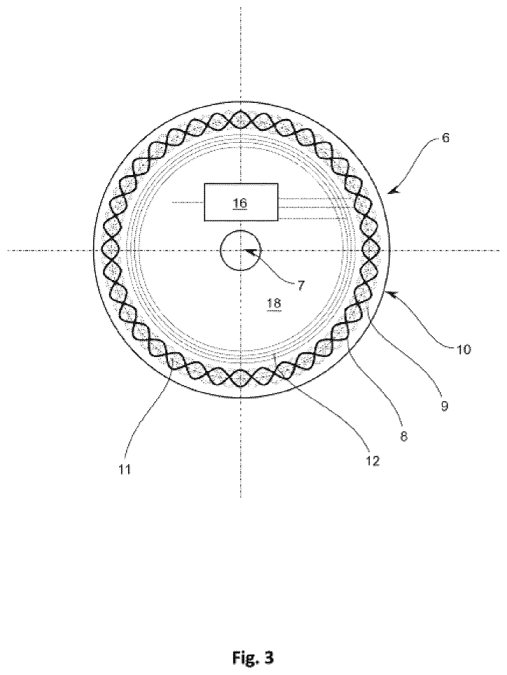

FIG. 3 shows the exposed inductive sensor 6. It can be seen that the sensor arrangement 1 has a control unit 16 which is connected to the third coil 12 for energizing and to the first coil 8 and the third coil 9 for evaluating signals. The control unit 16 is arranged in a region 17 which lies radially inside the third coil 12.

The first coil 8, the second coil 9 and the third coil 12 are formed on a common circuit board 18. As can be seen from FIG. 5, the control unit 16 is arranged on the circuit board 18.

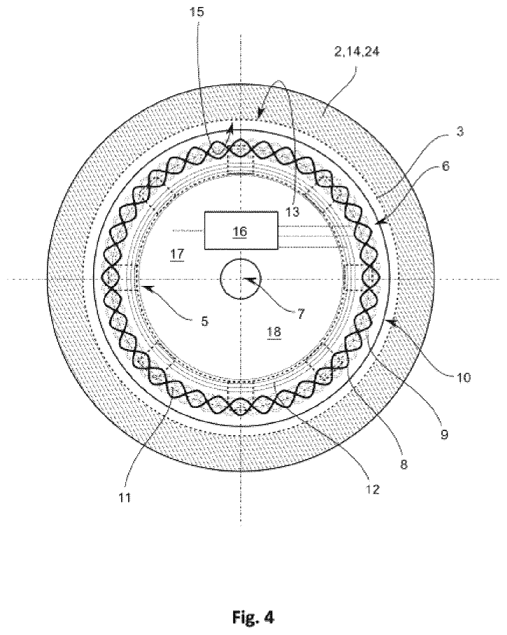

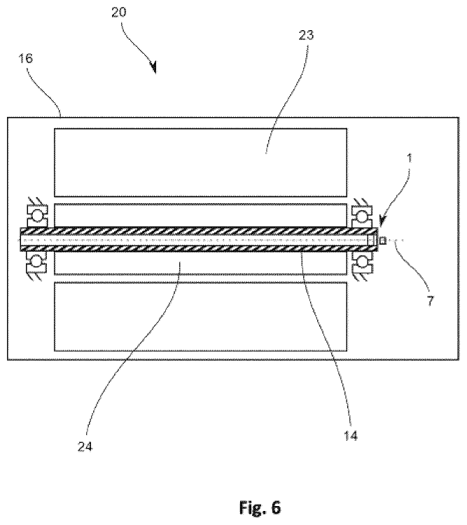

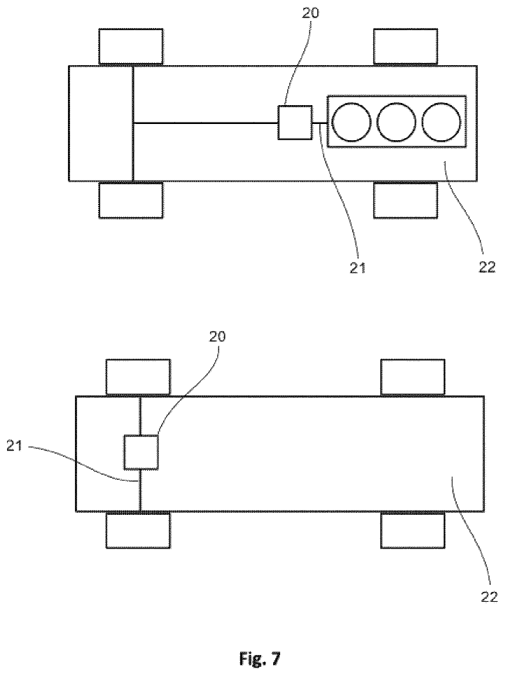

FIG. 6 shows an electric machine 20 for a hybrid or fully electrically operable drive train 21 of a motor vehicle 22, as also sketched in an exemplary manner in FIG. 7. The electric machine 20 comprises a stator 23 and a rotor 24 rotatable relative to the stator 23, wherein the electric machine 20 has a sensor arrangement 1, as shown in FIGS. 1-5, by means of which the angular position of the rotor 24 is determined.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### LIST OF REFERENCE SIGNS

1 Sensor arrangement
2 Shaft
3 Sensor target
4 Teeth
5 Grooves
6 Sensor
7 Axis of rotation
8 Coil
9 Coil
10 Plane
11 Circumference
12 Coil
13 Lateral surface
14 Hollow shaft
15 Lateral surface
16 Control unit
17 Region
18 Circuit board
20 Electric machine
21 Drive train
22 Motor vehicle
23 Stator
24 Rotor

1. A sensor arrangement for determining an angular position of a rotatable component, such as in particular a shaft, comprising:
a first annular sensor target with a plurality of teeth and grooves distributed equidistantly over the circumference and arranged in an alternating manner over the circumference, and also comprising:
a first inductive sensor, which is arranged at a distance axially from the first sensor target, and the sensor target and the first inductive sensor are rotatable in relation to one another about a common axis of rotation,
wherein the first inductive sensor has a first coil and a second coil, which respectively extend in a radial plane in relation to the axis of rotation,
wherein the first coil follows a sinusoidal path along a circular circumference and the second coil follows a path that is phase-offset thereto, in particular a cosinusoidal path, along the circular circumference,
wherein the first inductive sensor comprises an energizable third coil,
wherein the energizable third coil is arranged radially offset in the manner of a circular ring inside the first coil and the second coil, and the grooves are open radially inwards.

2. The sensor arrangement according to claim 1, wherein the sensor target has a basic shape in the manner of a circular ring.

3. The sensor arrangement according to claim 1, wherein the rotatable component rests at least in sections, preferably entirely, against the radially outer lateral surface of the sensor target.

4. The sensor arrangement according to claim 3, wherein the rotatable component is a hollow shaft with an inner lateral surface against which the radially outer lateral surface of the sensor target rests.

5. The sensor arrangement according to claim 4, wherein the sensor target is fixed axially and in a non-rotatable manner in the hollow shaft by means of an interference fit.

6. The sensor arrangement according to claim 1, wherein the sensor arrangement has a control unit which is connected to the third coil for energizing and to the first coil and the third coil for evaluating signals.

7. The sensor arrangement according to claim 6, wherein the control unit is arranged in a region which lies radially inside the third coils.

8. The sensor arrangement according to claim 1, wherein the first coil, the second coil and the third coil are formed on a common circuit board.

9. The sensor arrangement according to claim 1, wherein the control unit is arranged on the circuit board.

10. An electric machine of a motor vehicle, comprising a stator and a rotor rotatable relative to the stator, wherein the electric machine has a sensor arrangement according to claim 1 for determining the angular position of the rotor.

11. A sensor arrangement for determining an angular position of a rotatable component comprising:
a first annular sensor target including a plurality of teeth and grooves distributed in an alternating manner along the circumference of the first annular sensor target;
a first inductive sensor arranged at a distance axially from the first sensor target, wherein the first annular sensor target and the first inductive sensor are rotatable in relation to one another about a common axis of rotation,
wherein the first inductive sensor includes a first coil and a second coil, wherein the first coil and the second coil extend in a radial plane in relation to the axis of rotation,
wherein the first coil follows a sinusoidal path along a circular circumference and the second coil follows a path phase-offset relative to the sinusoidal path of the first coil along the circular circumference,
wherein the first inductive sensor comprises an energizable third coil, wherein the energizable third coil is radially offset inside the first coil and the second coil.

12. The sensor arrangement according to claim 11, the first annular sensor target has a shape of a circular ring.

13. The sensor arrangement according to claim 1, wherein the rotatable component rests in sections against an outer lateral surface of the first annular sensor target.

14. The sensor arrangement according to claim 13, wherein the rotatable component comprises a hollow shaft including an inner lateral surface, wherein the outer lateral surface of the first annular sensor target rests against the inner lateral surface.

15. The sensor arrangement according to claim 14, wherein the first annular sensor target is fixed axially in a non-rotatable manner in the hollow shaft.

16. The sensor arrangement according to claim 1, further comprising a control unit, wherein the control unit is connected to the third coil for energizing the third coil, wherein the control unit is connected to the first coil and the third coil for evaluating signals.

17. The sensor arrangement according to claim 16, the control unit is arranged in a region radially inside the third coil.

18. The sensor arrangement according to claim 11, wherein the first coil, the second coil, and the third coil are formed on a common circuit board.

19. The sensor arrangement according to claim 18, wherein the control unit is arranged on the common circuit board.

20. An electric machine of an electrical drive train comprising:
a stator;
a rotor rotatable relative to the stator; and
a sensor arrangement configured to determine the angular position of the rotor, wherein the sensor arrangement comprises:
a first annular sensor target including a plurality of teeth and grooves distributed in an alternating manner along the circumference of the first annular sensor target; and
a first inductive sensor arranged at a distance axially from the first sensor target, wherein the first annular sensor target and the first inductive sensor are rotatable in relation to one another about a common axis of rotation,
wherein the first inductive sensor includes a first coil and a second coil, wherein the first coil and the second coil extend in a radial plane in relation to the axis of rotation,
wherein the first coil follows a sinusoidal path along a circular circumference and the second coil follows a path phase-offset relative to the sinusoidal path of the first coil along the circular circumference,
wherein the first inductive sensor comprises an energizable third coil, wherein the energizable third coil is radially offset inside the first coil and the second coil.
